(19) United States
(12) Patent Application Publication
(10) Pub. No.: US 2007/0084367 A1
(43) Pub. Date: Apr. 19, 2007

(54) Printing device system and patterning method using the same

(76) Inventors: Hong Suk Yoo, Gunpo-si (KR); Tae Young Oh, Anyang-si (KR)

Correspondence Address: MCKENNA LONG & ALDRIDGE LLP;Song K. Jung, 1900 K Street, N.W., Washington, DC, 20006, US

(21) Appl. No.: 11/477,460

(22) Filed: Jun. 30, 2006

(30) Foreign Application Priority Data
Oct. 13, 2005 (KR) 10-2005-0096452

(51) Int. Cl. B41F 27/00

(52) U.S. Cl. 101/383

(57) ABSTRACT

A printing device system and a patterning method using the same is disclosed, to prevent the volume of blanket from being changed due to the dissolution of solvent included in the pattern material, to thereby realize a precise pattern, in which the printing device system comprises a printing roller having a blanket adhered to an outer surface thereof; and a drying device that dries the blanket of the printing roller.

This application claims the benefit of Korean Patent Application No. P2005-96452, filed on Oct. 13, 2005, which is hereby incorporated by reference for all purposes as if fully set forth herein.

### BACKGROUND OF THE INVENTION

1. Field of the Invention

The present invention relates to a liquid crystal display (LCD) device, and more particularly, to a method for forming a pattern of an LCD device by printing.

2. Discussion of the Related Art

Among various ultra-thin flat display devices, which include a display screen having a thickness of several centimeters, a liquid crystal display (LCD) device has been widely used for notebook computers, monitors, aircraft, etc., because it has advantages such as low power consumption and portability.

The LCD device includes lower and upper substrates facing each other with a predetermined gap therebetween, and a liquid crystal layer formed between the lower and upper substrates.

The lower substrate includes a thin film transistor and a pixel electrode, and the upper substrate includes a black matrix layer, a color filter layer and a common electrode.

The above LCD device includes various elements formed by repeated process steps. Especially, a photolithography process is used so as to form the elements in various shapes.

Photolithography uses a mask with a predetermined pattern and a light-emission device, thereby increasing the manufacturing cost. In addition, because the photolithography requires exposure and development, it results in a complicated process and an increased manufacturing time.

To overcome these problems with photolithography, a new patterning method has been developed, for example, a printing method. In the printing method, a material is coated on a printing roller, and then the printing roller is rotated on a substrate to thereby form a pattern on the substrate.

Hereinafter, a related art printing method will be described with reference to the accompanying drawings.

FIGS. 1A to 1C are cross sectional views of illustrating a printing method according to the related art.

As shown in FIG. 1A, first, a pattern material 20 is provided through a printing nozzle 10 and is coated on a printing roller 30. At this time, a blanket 35 is adhered onto an outer surface of the printing roller 30. That is, the pattern material 20 is coated onto the surface of the blanket 35.

The blanket 35 needs to adhere well to the printing roller 30 and needs to resist deformation during the printing process. To this end, the blanket 35 is generally formed of a Si-based resin.

Then, as shown in FIG. 1B, the printing roller 30 is rotated on a cliché plate 40 having concave 43 and convex 46 portions. That is, some pattern material 20a is transferred to the convex portions 46 of the cliché plate 40, and the remaining pattern material 20b is left on the surface of the printing roller 30, whereby a desired pattern 20b is formed on the blanket 35 of the printing roller 30 by the remaining pattern material 20b.

As shown in FIG. 1C, as the printing roller 30 is rotated on a substrate 50, the predetermined pattern 20b of the printing roller 30 is transferred to the substrate 50.

Unlike photolithography, the printing method requires no exposure and development. Thus, the printing method is a simpler process and decreases the manufacturing cost, whereby the printing method is appropriate for the mass production of an LCD device.

However, when repeating the patterning process by printing, the blanket 35 of the printing roller 30 is deformed due to the pattern material 20. That is, a solvent in the pattern material 20 dissolves the blanket 35, whereby the blanket 35 swells. Accordingly, it is impossible to realize a precise pattern due to the deformation of blanket 35.

As shown in FIG. 2A, when the printing roller 30 having the blanket 35 coated with the pattern material 20 is rotated on the cliché plate 40 including the concave and convex portions 43 and 46 and if the blanket 35 is swollen, the pattern material 20 contacts with the concave portions 43. In this case, as shown in FIG. 2B, the pattern material 20a and 20b is transferred to the concave portions 43 as well as the convex portions 46. Accordingly, the pattern material 20c being left on the blanket 35 of the printing roller 30 is not in the desired pattern. As a result, it is impossible to realize the precise pattern because area ‘A’ of FIG. 2B has no pattern material.

### SUMMARY OF THE INVENTION

Accordingly, the present invention is directed to a printing device system and a patterning method using the same that substantially obviates one or more problems due to limitations and disadvantages of the related art.

An advantage of the present invention is to provide a printing device system to prevent a pattern defect caused by a change in volume of a blanket adhered to a surface of a printing roller.

Another advantage of the present invention is to provide a patterning method using a printing device system to realize a precise pattern.

Additional features and advantages of the invention will be set forth in the description which follows and in part will be apparent from the description or may be learned from practice of the invention. The objectives and other advantages of the invention may be realized and attained by the structure particularly pointed out in the written description and claims hereof as well as the appended drawings.

To achieve these and other advantages and in accordance with the purpose of the present invention, as embodied and broadly described herein, a printing device system includes a printing roller having a blanket adhered to an outer surface thereof and a drying device that dries the blanket of the printing roller.

In another aspect of the present invention, a patterning method includes: forming a predetermined pattern material on a printing roller having a blanket adhered to an outer surface thereof; rotating the pattern material on a substrate so as to transfer the pattern material on the substrate; and drying the blanket of the printing roller.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention.

In the drawings:

FIGS. 1A to 1C are cross sectional views illustrating a printing method according to the related art;

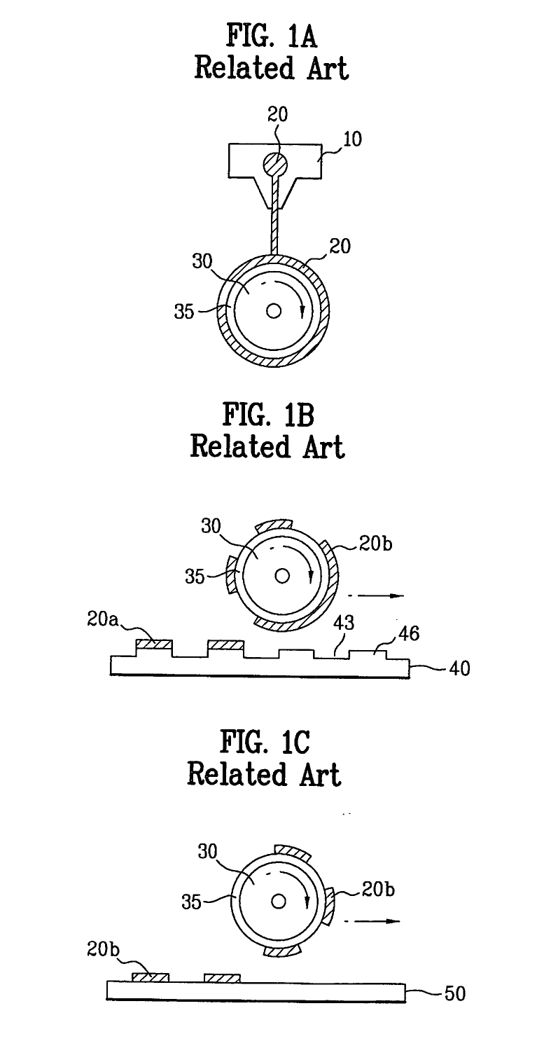

FIGS. 2A and 2B are cross sectional views explaining problems of a printing method according to the related art;

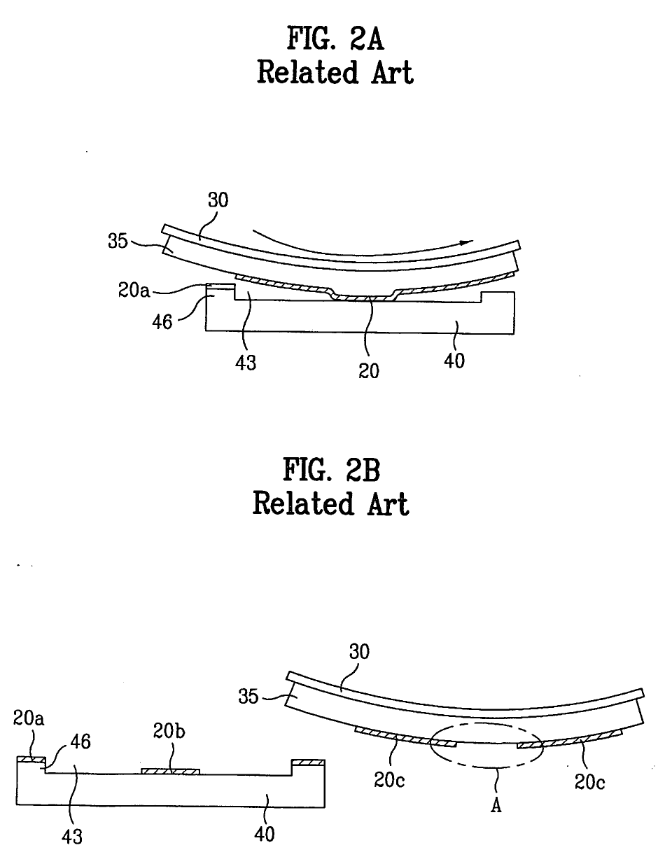

FIG. 3 is a schematic view of a printing device system according to the first embodiment of the present invention;

FIG. 4A is a bottom view illustrating a drying device according to one preferred embodiment of the present invention, and FIG. 4B is a cross sectional view illustrating a drying device according to one preferred embodiment of the present invention;

FIG. 5A is a bottom view illustrating a drying device according to another preferred embodiment of the present invention, and FIG. 5B is a cross sectional view illustrating a drying device according to another preferred embodiment of the present invention; and

FIG. 6 is a schematic view illustrating a printing device system according to the second embodiment of the present invention.

### DETAILED DESCRIPTION OF THE ILLUSTRATED EMBODIMENTS

Reference will now be made in detail to the embodiments of the present invention, examples of which are illustrated in the accompanying drawings. Wherever possible, the same reference numbers will be used throughout the drawings to refer to the same or like parts.

Hereinafter, a printing device system according to the present invention will be described as follows.

First Embodiment

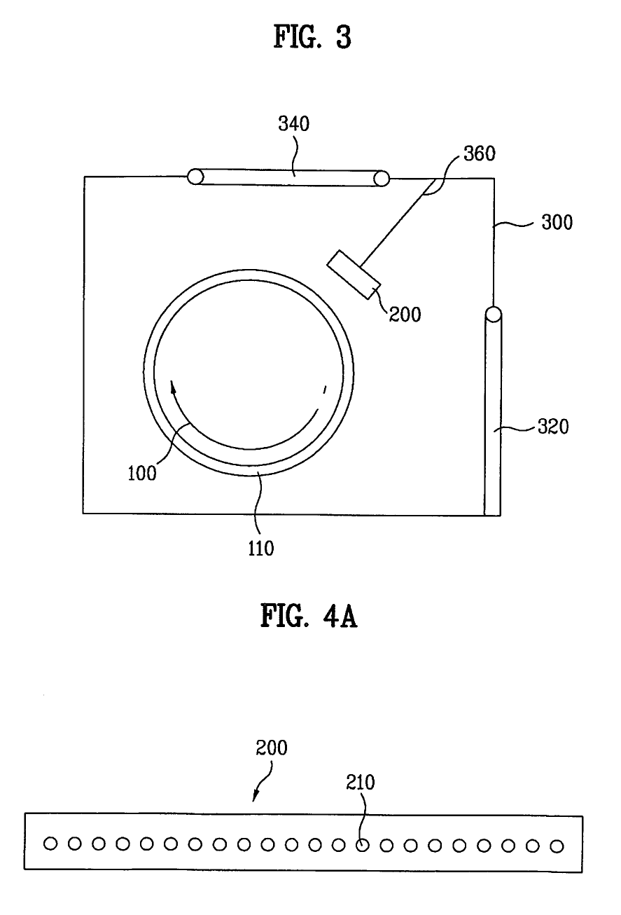

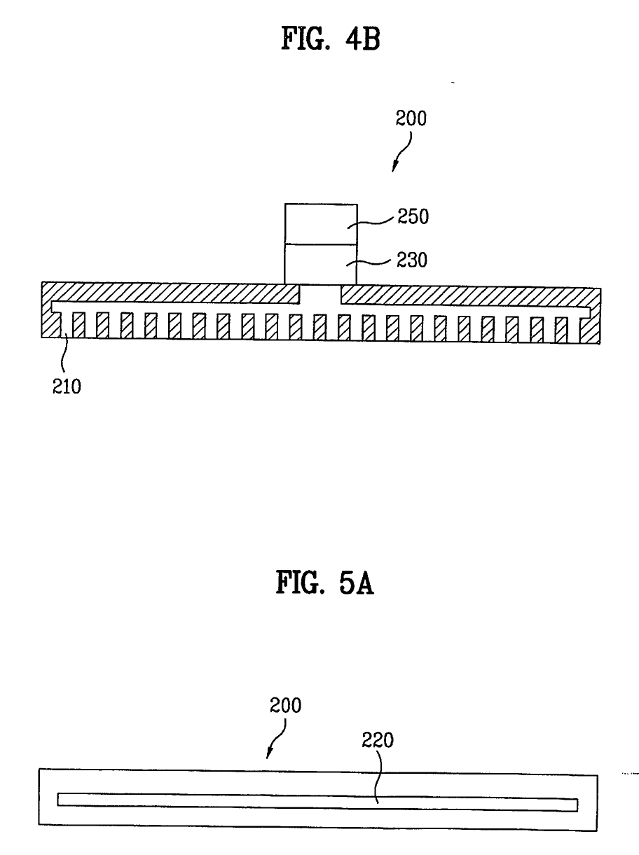

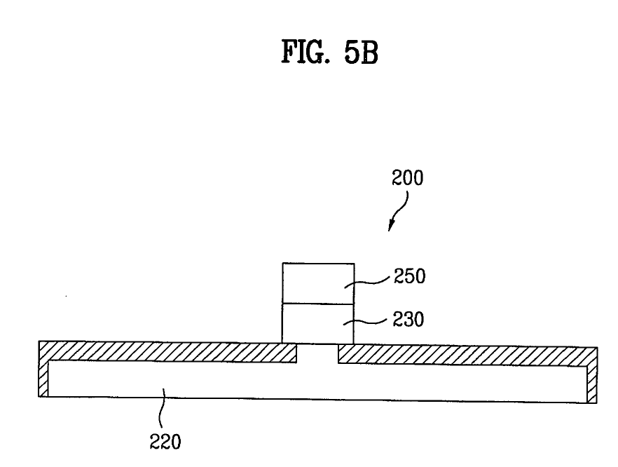

FIG. 3 is a schematic view of a printing device system according to the first embodiment of the present invention. FIG. 4A is a bottom view illustrating a drying device according to one preferred embodiment of the present invention, and FIG. 4B is a cross sectional view illustrating a drying device according to one preferred embodiment of the present invention. FIG. 5A is a bottom view illustrating a drying device according to another preferred embodiment of the present invention, and FIG. 5B is a cross sectional view illustrating a drying device according to another preferred embodiment of the present invention.

As shown in FIG. 3, a printing device system according to the first embodiment of the present invention includes a printing roller 100 and a drying device 200. At this time, a blanket 110 is adhered to an outer surface of the printing roller 100. The drying device 200 dries the blanket 110 of the printing roller 100, wherein the drying device 200 is comprised of an air bar 200 for discharging air.

The air bar 200 of the drying device 200 will be explained with reference to FIGS. 4 and 5.

As shown in FIGS. 4A and 4B, the air bar 200 may include a plurality of holes 210, an air filter 230, and a temperature controller 250. As shown in FIGS. 5A and 5B, the air bar 200 may include a slit 220 for discharging air, an air filter 230, and a temperature controller 250. That is, the air bar 200 discharges the air through the plurality of holes 210 of FIG. 4 or through the slit 220 of FIG. 5, to thereby dry the blanket 110.

Also, the air filter 230 filters the discharged air so as to prevent foreign materials in the discharged air from getting stick to the blanket 110.

The temperature controller 250 controls a temperature of the discharged air for the optimal drying state of the blanket 110.

Referring to FIG. 3, the printing roller 100 and the drying device 200 are contained in a chamber 300. As the printing roller 100 and the drying device 200 are tightly sealed by the chamber 300, it is possible to dry the blanket 110 of the printing roller 100 while minimizing the foreign materials.

In addition, a hydraulic device 360 is provided in the chamber 300. One end of the hydraulic device 360 is connected with the chamber 300, and the other end of the hydraulic device 360 is connected with the drying device 200. The hydraulic device 360 controls a gap between the drying device 200 and the printing roller 100.

The chamber 300 includes an inlet 320 for the printing roller 100. The chamber 300 includes an inlet 340 for a printing nozzle that supplies a pattern material to the printing roller 100.

Second Embodiment

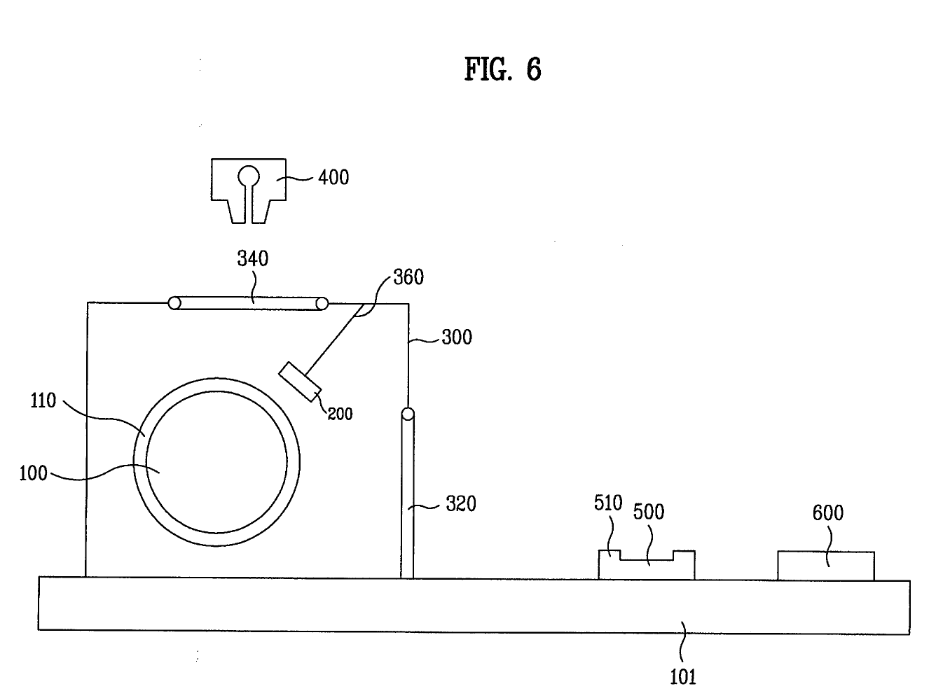

FIG. 6 is a schematic view illustrating a printing device system according to the second embodiment of the present invention.

As shown in FIG. 6, a printing device system according to the second embodiment of the present invention includes a rail 101, a printing roller 100, a drying device 200, a chamber 300 for accommodating the printing roller 100 and the drying device 200, a printing nozzle 400, a cliché plate 500, and a substrate 600. The rail 101 may be any sort of conveyor that will allow the movement of the various parts of the printing device system.

The printing roller 100, the drying device 200, and the chamber 300 of the second embodiment are identical in structure to those of the first embodiment. The blanket 110 is adhered to an outer surface of the printing roller 100. Also, the drying device 200 may include an air bar including a plurality of holes 210, an air filter 230, and a temperature controller 250 as shown in FIG. 4, or may include an air bar including a slit 220, an air filter 230, and a temperature controller 250 as shown in FIG. 5.

The chamber 300 includes a hydraulic device 360 that controls a gap between the drying device 200 and the printing roller 100, an inlet 320 for the printing roller 100, and an inlet 340 for the printing nozzle 400.

The printing roller 100 moves to the printing nozzle 400, the cliché plate 500, and the substrate 600 along the rail 101, so as to form a pattern on the substrate 600. After a pattern material supplied from the printing nozzle 400 is coated on the printing roller 100, a predetermined pattern is formed on the printing roller 100 using the cliché plate 500. Then, the predetermined pattern of the printing roller 100 is transferred to the substrate 600.

Although not shown, a cleaning device for cleaning the cliché plate 500 may additionally be provided on the rail 101.

The drying device 200, the printing nozzle 400, the cliché plate 500, and the substrate 600 are maintained in the fixed position, and the printing roller 101 is moved along the rail 101.

Hereinafter, a patterning method using the above printing device system according to the present invention will be described as follows.

The patterning method includes: forming a predetermined pattern on a printing roller having a blanket adhered thereto; transferring the predetermined pattern of the printing roller to a substrate by rotating the printing roller on the substrate; and drying the blanket of the printing roller. This patterning method may be performed with the printing device system of FIG. 6 that will be explained with reference to FIG. 6.

First, the printing nozzle 400 enters the inside of the chamber 300 through the inlet 340. Then, the pattern material is provided through the printing nozzle 400 and is coated onto the blanket 110 of the printing roller 100.

Thereafter, the printing roller 100 is moved outside of the chamber 300 through the inlet 320. Then, the printing roller 100 is moved to the cliché plate 500 along the rail 101. The pattern material is printed on the cliché plate 500.

The cliché plate 500 includes predetermined projections 510. The pattern material of the printing roller 100 is transferred onto the projection 510 of the cliché plate 500. Then, the pattern material is left in a predetermined form on the printing roller 100.

After the printing roller 100 moves to the substrate 600 along the rail 101, the predetermined pattern material is transferred to the substrate 600.

Then, the printing roller 100 moves inside of the chamber 300 along the rail 101, and the blanket 110 of the printing roller 100 is dried by the drying device 200.

As shown in FIGS. 4 and 5, the air bar of the drying device 200 includes the temperature controller 250 to control the temperature of air discharged for drying the blanket 110 of the printing roller 100. If drying the blanket 110 with the high-temperature air, the blanket 110 may be changed in elasticity and volume. Therefore, it is preferable to use room-temperature air.

As mentioned above, the printing device system and patterning method using the same according to the present invention has the following advantages.

In the printing device system and patterning method using the same according to the present invention, the drying device is additionally provided to dry the blanket of the printing roller. Accordingly, it is possible to prevent the volume of blanket from being changed due to the dissolution of solvent included in the pattern material, thereby realizing a precise pattern.

Also, the printing roller and the drying device are positioned inside the chamber. Thus, the drying process is performed so as to minimize environmental interference.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A printing device system comprising:
a printing roller having a blanket adhered to an outer surface thereof; and
a drying device for drying the blanket of the printing roller.

2. The system of claim 1, wherein the drying device includes an air bar that discharges air.

3. The system of claim 2, wherein the air bar includes a plurality of holes that discharges air.

4. The system of claim 2, wherein the air bar includes a slit that discharges air.

5. The system of claim 2, wherein the air bar includes a temperature controller that controls a temperature of discharged air.

6. The system of claim 2, wherein the air bar includes an air filter that filters the discharged air.

7. The system of claim 1, further comprising a chamber that accommodates the printing roller and the drying device.

8. The system of claim 7, further comprising a hydraulic device that controls a gap between the printing roller and the drying device, the hydraulic device having one end connected with the chamber and the other end connected with the drying device.

9. The system of claim 7, wherein the chamber includes an inlet for the printing roller.

10. The system of claim 7, wherein the chamber includes an inlet for a printing nozzle.

11. A printing device system comprising:
a conveyor;
a printing nozzle, a cliché plate, and a substrate sequentially positioned on the conveyor;
a printing roller having a blanket adhered to an outer surface thereof and moving to the printing nozzle, the cliché plate, and the substrate along the conveyor; and
a drying device positioned over the conveyor that dries the blanket of the printing roller.

12. The system of claim 11, wherein the drying device includes an air bar that discharges air.

13. The system of claim 12, wherein the air bar includes a plurality of holes that discharges air.

14. The system of claim 12, wherein the air bar includes a slit that discharges air.

15. The system of claim 12, wherein the air bar includes a temperature controller that controls a temperature of discharged air.

16. The system of claim 12, wherein the air bar includes an air filter that filters the discharged air.

17. The system of claim 11, further comprising a chamber that accommodates the printing roller and the drying device.

18. The system of claim 17, further comprising a hydraulic device that controls a gap between the printing roller and the drying device, the hydraulic device having one end connected with the chamber and the other end connected with the drying device.

19. The system of claim 17, wherein the chamber includes an inlet for the printing roller.

20. The system of claim 17, wherein the chamber includes an inlet for the printing nozzle.

21. The system of claim 11, further comprising a cleaning device that cleans the cliché plate.

22. A patterning method comprising:
forming a predetermined pattern material on a printing roller having a blanket adhered to an outer surface thereof;
rotating the pattern material on a substrate so as to transfer the pattern material on the substrate; and
drying the blanket of the printing roller.

23. The method of claim 22, wherein the process of drying the blanket of the printing roller is performed with air discharged from an air bar.

24. The method of claim 23, wherein the discharged air corresponds to room-temperature air.

25. The method of claim 23, wherein the air bar includes a plurality of holes that discharges air.

26. The method of claim 23, wherein the air bar includes a slit that discharges air.

27. The method of claim 23, wherein the air bar includes a temperature controller that controls the air discharged from the air bar.

28. The method of claim 23, wherein the air bar includes an air filter that filters the air discharged from the air bar.

29. The method of claim 22, wherein the process of drying the blanket of the printing roller is performed in a chamber.

30. A patterning method comprising:
moving a printing nozzle to the inside of a chamber through a first inlet and supplying a pattern material by the printing nozzle to a blanket adhered to a printing roller;
moving the printing roller to the outside of the chamber through a second inlet;
rotating the printing roller on a cliché plate having a projection so as to transfer some pattern material onto the projection of the cliché plate and to leave the pattern material with a predetermined form on the printing roller;
rotating the printing roller on a substrate to transfer the predetermined form of the pattern material to the substrate; and
moving the printing roller to the inside of the chamber and drying the blanket of the printing roller.

31. The method of claim 30, wherein the process of drying the blanket is performed with air discharged from an air bar.

32. The method of claim 31, wherein the air corresponds to room-temperature air.

33. The method of claim 31, wherein the air bar includes a plurality of holes.

34. The method of claim 31, wherein the air bar includes a slit.

35. The method of claim 31, wherein the air bar includes a temperature controller that controls a temperature of air discharged from the air bar.

36. The method of claim 31, wherein the air bar includes an air filter that filters the air discharged from the air bar.

37. The method of claim 30, wherein the process of drying the blanket is performed in the chamber.
